(19) United States
(12) Patent Application Publication
(10) Pub. No.: US 2017/0017116 A1
(43) Pub. Date: Jan. 19, 2017

(54) SUBSTRATES HAVING POLARIZER AND COLOR FILTER FUNCTIONS, AND METHODS FOR THEIR PREPARATIONS

(71) Applicant: EMPIRE TECHNOLOGY DEVELOPMENT LLC, Wilmington, DE (US)

(72) Inventor: Toshimi FUKUI, Otsu (JP)

(73) Assignee: Empire Technology Development LLC, Wilmington, DE (US)

(21) Appl. No.: 15/121,788

(22) PCT Filed: Mar. 5, 2015
(86) PCT No.: PCT/US2015/018882

§ 371 Date: Aug. 26, 2016

Related U.S. Application Data
(60) Provisional application No. 61/949,492, filed on Mar. 7, 2014.

(51) Int. Cl. G02F 1/1335

(52) U.S. Cl. CPC G02F 1/133533; G02F 1/133512; G02F 2001/133538; G02F 2001/133302

(57) ABSTRACT

A liquid crystal display glass substrate can include a plurality of red, green and blue polarizing regions configured to polarize red, green and blue light, respectively. A red, green or blue color pixel can be disposed on a respective polarizing region. Each polarizing region can include at least one array of nanostructures having parallel projections and recesses embedded in the substrate. A refractive index of the projections can be different from a refractive index of the recesses.

Smartphones, tablets, personal computers (PCs), and devices with liquid crystal displays (LCDs) have recently formed large markets, become popular types of mobile terminals, and dramatically changed the lifestyles of users. However, there remains a need to reduce the weight of these devices. Due to the large number of components in conventional LCDs, it is difficult to reduce the weight of LCD devices and the cost, time, and complexity of manufacturing such devices.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

In some embodiments, a substrate can comprise a plurality of polarizing regions configured to polarize light, each polarizing region comprising at least one array of nanostructures embedded in the substrate, wherein the at least one array of nanostructures comprises parallel projections and recesses, wherein a refractive index of the projections is different from a refractive index of the recesses, wherein each polarizing region has a transmission coefficient equal to or less than about 10⁻⁴ for light orthogonal to the parallel projections and recesses, and wherein the plurality of polarizing regions comprise a red polarizing region configured to polarize light having a wavelength of about 620 nm to about 750 nm, a green polarizing region configured to polarize light having a wavelength of about 495 nm to about 570 nm, and a blue polarizing region configured to polarize light having a wavelength of about 450 nm to about 495 nm.

In some embodiments, a liquid crystal display can comprise a first substrate comprising a plurality of polarizing regions configured to polarize light, each polarizing region comprising an array of nanostructures embedded in the first substrate, wherein the array of nanostructures comprises parallel projections and recesses, wherein a refractive index of the projections is different from a refractive index of the recesses, wherein each polarizing region has a transmission coefficient equal to or less than about 10⁻⁴ for light orthogonal to the parallel projections and recesses, and wherein the plurality of polarizing regions comprise a red polarizing region configured to polarize light having a wavelength of about 620 nm to about 750 nm, a green polarizing region configured to polarize light having a wavelength of about 495 nm to about 570 nm, and a blue polarizing region configured to polarize light having a wavelength of about 450 nm to about 495 nm; a black matrix formed on regions of the substrate outside of the polarizing regions, wherein the black matrix defines a plurality of openings between pairs of the polarizing regions. In some embodiments, the liquid crystal display can further comprise a plurality of color pixels disposed on the plurality of polarizing regions, wherein each of the color pixels is disposed on a respective polarizing region associated with a color of the color pixel; a second substrate; and a liquid crystal layer disposed between the first and second substrates.

In some embodiments, a method of making a substrate can comprise forming a plurality of arrays of nanostructures embedded in the substrate, wherein each array of nanostructures comprises parallel projections and recesses, wherein a refractive index of the projections is different from a refractive index of the recesses, and wherein each array is configured to polarize light and has a transmission coefficient equal to or less than about 10⁻⁴ for light orthogonal to the parallel projections and recesses. In some embodiments, the method of making a substrate can further comprise depositing a black matrix on regions of the substrate outside of the arrays of nanostructures, such that the black matrix defines a plurality of openings between pairs of the arrays of nanostructures; and depositing a color pixel composition onto one or more of the plurality of arrays of nanostructures.

In some embodiments, a method of making a substrate can comprise forming a plurality of arrays of nanostructures embedded in the substrate, wherein each array of nanostructures comprises parallel projections and recesses, wherein a refractive index of the projections is different from a refractive index of the recesses, wherein each array is configured to polarize light and has a transmission coefficient equal to or less than about 10⁻⁴ for light orthogonal to the parallel projections and recesses, and wherein the plurality of arrays of nanostructures form a plurality of polarizing regions, the plurality of polarizing regions comprising a red polarizing region configured to polarize light having a wavelength of about 620 nm to about 750 nm, a green polarizing region configured to polarize light having a wavelength of about 495 nm to about 570 nm, and a blue polarizing region configured to polarize light having a wavelength of about 450 nm to about 495 nm.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 illustrates a cross-sectional view of a liquid crystal display device with a top glass substrate having embedded polarizing functionality and embedded color-filtering functionality.

FIG. 2 illustrates a top view of glass substrate with embedded polarizing functionality.

FIG. 3 illustrates a perspective view of a polarizing region on a glass substrate.

FIG. 4 illustrates a cross-sectional view of one embodiment of a glass substrate with embedded polarizing functionality and embedded color-filtering functionality.

FIG. 5 illustrates a cross-sectional view of another embodiment of a glass substrate with embedded polarizing functionality and embedded color-filtering functionality.

FIG. 6 illustrates a cross-sectional view of another embodiment of a glass substrate with embedded polarizing functionality and embedded color-filtering functionality.

FIG. 7 illustrates a cross-sectional view of another embodiment of a glass substrate with embedded polarizing functionality and embedded color-filtering functionality.

FIG. 8 illustrates a cross-sectional view of another embodiment of a glass substrate with embedded polarizing functionality and embedded color-filtering functionality.

FIG. 9 illustrates a graph showing the values of projection ratio and projection width for which a transmission coefficient of 10⁻⁴ or less can be achieved for a polarizing region embedded in a glass substrate according to one embodiment.

FIG. 10 illustrates a graph showing the values of projection ratio and projection width for which a transmission coefficient of 10⁻⁴ or less can be achieved for a polarizing region embedded in a glass substrate according to another embodiment.

FIG. 11 illustrates a graph showing the values of projection ratio and projection width for which a transmission coefficient of 10⁻⁴ or less can be achieved for a polarizing region embedded in a glass substrate according to another embodiment.

FIG. 12 illustrates a graph showing the values of projection ratio and projection width for which a transmission coefficient of 10⁻⁴ or less can be achieved for a polarizing region embedded in a glass substrate according to another embodiment.

FIG. 13 illustrates a graph showing the values of projection ratio and projection width for which a transmission coefficient of 10⁻⁴ or less can be achieved for a polarizing region embedded in a glass substrate according to another embodiment,

FIG. 14 illustrates one embodiment of making a glass substrate with embedded polarizing functionality and embedded color-filtering functionality.

FIG. 15 illustrates another embodiment of making a glass substrate with embedded polarizing functionality and embedded color-filtering functionality.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Conventional liquid crystal display (LCD) devices include multiple components that add to the weight and costs of the device. Examples of such components include glass substrates, polarizers, color filters, transparent conductive films, thin-film transistors, alignment layers, liquid crystal layers, and multiple other components. In contrast, the embodiments disclosed herein are able to omit conventional polarizers and color filters by embedding polarizing functionality and color-filtering functionality into a glass substrate.

In particular, according to some embodiments, a substrate may include a plurality of polarizing regions configured to polarize light, each polarizing region having at least one array of nanostructures embedded in the substrate. The array of nanostructures may have parallel projections and recesses. The projections may have a refractive index that is different from that of the recesses. Each polarizing region may have a transmission coefficient equal to or less than about 10⁻⁴ for light orthogonal to the parallel projection and recesses. The plurality of polarizing regions can include regions for polarizing red light, regions for polarizing green light, and regions for polarizing blue light. For example, the plurality of polarizing regions may include a red polarizing region configured to polarize light having a wavelength of about 620 nm to about 750 nm, a green polarizing region configured to polarize light having a wavelength of about 495 nm to about 570 nm, and a blue polarizing region configured to polarize light having a wavelength of about 450 nm to about 495 nm. The substrate can, for example, be a glass substrate.

In addition, the polarizing regions can include a plurality of color pixels, such as red, green or blue color pixels, disposed on the polarizing regions. In some embodiments, the color pixels fill the recesses, so that the recesses contain color pixels. In other embodiments, the recesses contain air. In some embodiments, the plurality of color pixels include at least one red color pixel disposed on the red polarizing region, at least one green color pixel disposed on the green polarizing region, and at least one blue color pixel disposed on the blue polarizing region. In some embodiments, the substrate may include at least one divot, each divot configured to receive a color pixel and the at least one array of nanostructures. For example, the color pixels can be disposed in divots embedded in the glass substrate. Accordingly, the LCD devices disclosed herein can be thinner, lighter, and more cost efficient compared to conventional LCD glass substrates, due to the embedded nature of the polarizing regions and the color pixels. In addition, light usage efficiency can be improved due to the thinness of the LCD device and the fewer number of components compared to conventional devices.

FIG. 1 illustrates a side cross sectional view of a LCD device 100 according to some embodiments. Some of the components illustrated in FIG. 1 are known in the art, such as a backlight 110, a bottom polarizer 120, a bottom glass substrate 130, and a liquid crystal layer 140. However, unlike conventional LCD devices, the LCD device 100 illustrated in FIG. 1 does not include a conventional top polarizer and a color filter. Instead, the LCD device 100 illustrated in FIG. 1 has polarizing regions 150 and color pixels 160 embedded in the top glass substrate 170.

FIG. 2 illustrates a top view of the top LCD glass substrate 170 with a plurality of polarizing regions 150. In some embodiments, the plurality of color pixels 160 (not shown in FIG. 2) is embedded in the glass substrate 170 on top of the polarizing regions 150. In some embodiments, a black matrix can be formed on regions of the substrate outside of the polarizing regions 150. The black matrix may define a plurality of openings between pairs of the polarizing regions. The plurality of color pixels may be disposed on the plurality of polarizing regions, such that each of the color pixels is disposed on a respective polarizing region associated with a color of the color pixel.

FIG. 3 illustrates a perspective view of one of the polarizing regions 150 in FIG. 2. As illustrated in FIG. 3, each polarizing region has an array of nanostructures, specifically, a plurality of parallel projections 310 and recesses 320. The array of nanostructures can be formed by imprinting, for example glass imprinting, according to some embodiments. In some embodiments, the width of each of the projections 310 is about 120 nm to 300 nm. For example, the width may be about 120 nm, about 140 nm, about 160 nm, about 180 nm, about 200 nm, about 220 nm, about 240 nm, about 260 nm, about 280 nm, about 300 nm, or a width between any of these values. In addition, in some embodiments, the total width of all of the projections 310 may be about 15% to about 30% of the total width of the nanostructure array. As used herein, “projection ratio” may refer to the percentage of the width of the nanostructure array occupied by the projections 310. For example, the projection ratio can be about 15%, about 18%, about 21%, about 24%, about 27%, about 30% or a percentage between any of these values. In some embodiment, the projections 310 and recesses 320 can be at a constant pitch or at a variable pitch. Further, the height of the projections can be about 5 μm to 20 μm, or about 5 μm to 10 μm in some embodiments. For example, the height may be about 5 μm, about 8 μm, about 11 μm, about 14 μm, about 17 μm, about 20 μm, or a height between any of these values.

In some embodiments, the dimensions of the nanostructures in one array can be different from the dimensions of the nanostructures in another array. Specifically, some embodiments have multiple subsets, for example three subsets, of nanostructure arrays, each subset with dimensions that are different from those of another subset. Each subset of nanostructure arrays can be configured to polarize different colored lights, such as red light, green light, and blue light. Light transmitted through the polarizing regions 150 can become polarized due to the configuration (for example, dimensions and shape) of the parallel projections 310 and recesses 320.

In some embodiments, the projections 310 and recesses 320 have different indices of refraction. As the projections 310 are protrusions of the glass substrate 170 according to some embodiments, as illustrated in FIG. 3, the projections 310 can have an index of refraction that is the same as that of the glass substrate 170. In some embodiments, the refractive index of the projections 310 (and the glass substrate 170) can be about 1.40 to 1.64. For example, the refractive index can be about 1.40, about 1.44, about 1.48, about 1.52, about 1.56, about 1.60, about 1.64, or a refractive index between any of these values. In some embodiments, the refractive index of the projections 310 (and the glass substrate 170) is about 1.51. In some embodiments, the recesses 320 may include air. The recesses 320 can have an index of refraction that is substantially the same as that of air for example 1.00. In some embodiments, the recesses may include air with a refractive index of about 1. In other embodiments, the recesses 320 may include a color pixel. The recesses 320 can have an index of refraction that is substantially the same as that of the respective color pixel residing therein. In some embodiments, each of the recesses may include a color pixel with a refractive index of about 1.80 to about 1.85. For example, the refractive index can be about 1.80, about 1.81, about 1.82, about 1.83, about 1.84, about 1.85 or a refractive index between any of these values. Light transmitted through the polarizing regions 150 of nanostructures can become polarized due to the difference in the refractive index between the projections 310 (for example, the refractive index of the glass substrate 170) and the refractive index of the recesses 320 (for example, the refractive index of air or a color pixel). In particular, the polarizing regions 150 can have a transmission coefficient equal to or less than about 10⁻⁴ for light that is orthogonal to the projections 310 and recesses 320.

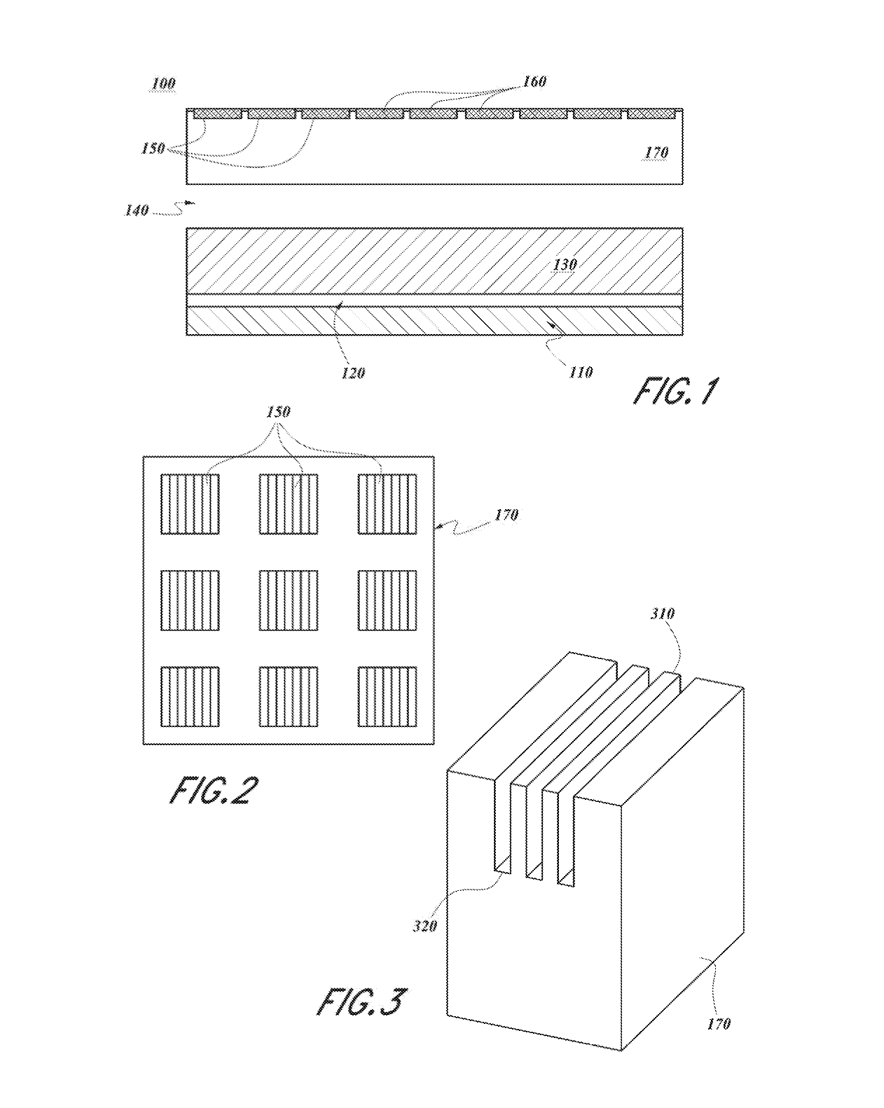

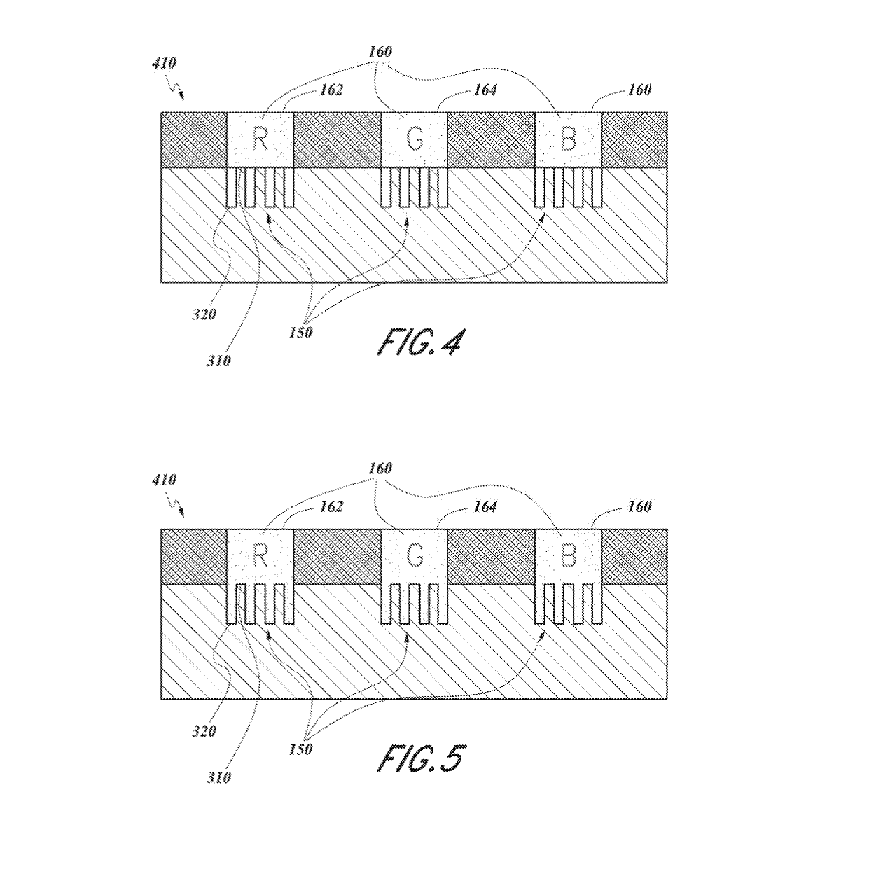

FIG. 4 illustrates a side cross sectional view of one embodiment of a LCD glass substrate 170 with embedded polarizing regions 150 and embedded color pixels 160. As illustrated in FIG. 4, the color pixels 160 can include a red color pixel 162, a green color pixel 164, and a blue color pixel 166, each disposed on top of a polarizing region 150. In some embodiments, the color pixels 160 are arranged in a RGB three color pattern. FIG. 4 also illustrates a black matrix 410 formed on regions of the substrate 170 outside of the polarizing regions 150 and color pixels 160. The black matrix 410 can define a plurality of openings between pairs of the polarizing regions 150. As illustrated in FIG. 4, the recesses 320 in the polarizing regions 150 can include air. Referring to FIG. 4, in some embodiments the color pixels can be formed by transcription or by any other suitable method. In other embodiments, as illustrated in FIG. 5, the recesses 320 can include a color pixel 160. Thus, in some embodiments, the color pixels 160 can fill the recesses 320. Referring to FIG. 5, the color pixels 160 and the black matrix 410 can be formed by ink-jet printing or off-set printing on the polarizing regions 150 having the array of nanostructures, or by any other suitable method.

In some embodiments, the composition of the color pixels 160 is nanoparticle-based instead of pigment based. Thus, the color pixels 160 can filter color according to principles of surface plasmon absorption. Specifically, when light is incident on the color pixel 160, surface plasmon resonance can be generated due to the nanoparticles. In addition, the nanoparticles can suppress scattering and ensure a higher light transmittance compared to pigment-based color filters. In some embodiments, the composition of the color pixels 160 includes inorganic nanoparticles dispersed in a chemically stable matrix composition with high heat resistance. For example, the matrix composition can be polysilsesquioxane, polycarbosilane, polyborosilazane, polycarbosilazane, polyborosiloxane, or a combination thereof.

In some embodiments, the nanoparticles dispersed in the color pixels 160 can include a shell and a core. The material of the shell and/or core can be gold (Au), silver (Ag), copper (Cu) or a combination thereof. Nanoparticles with a gold core and a silver shell can exhibit colors ranging from red to orange to yellow. Nanoparticles with a copper shell can exhibit colors ranging from red to violet to blue to bluish green. In addition, the nanoparticles can have an average diameter of about 2 nm to about 20 nm, for example about 2 nm, about 4 nm, about 6, about 8 nm, about 10 nm, about 12 nm, about 14 nm, about 16 nm, about 18 nm, about 20 nm, or an average diameter between any of these values. In some embodiments, the average diameter of the inorganic nanoparticles is about 10 nm. Although nanoparticle-based color pixels 160 are described in the context of LCD glass substrates with embedded polarizers 150 and embedded color filters 160, it will be appreciated that the color pixels 160 described herein can be used in any application in which a color filter would be useful.

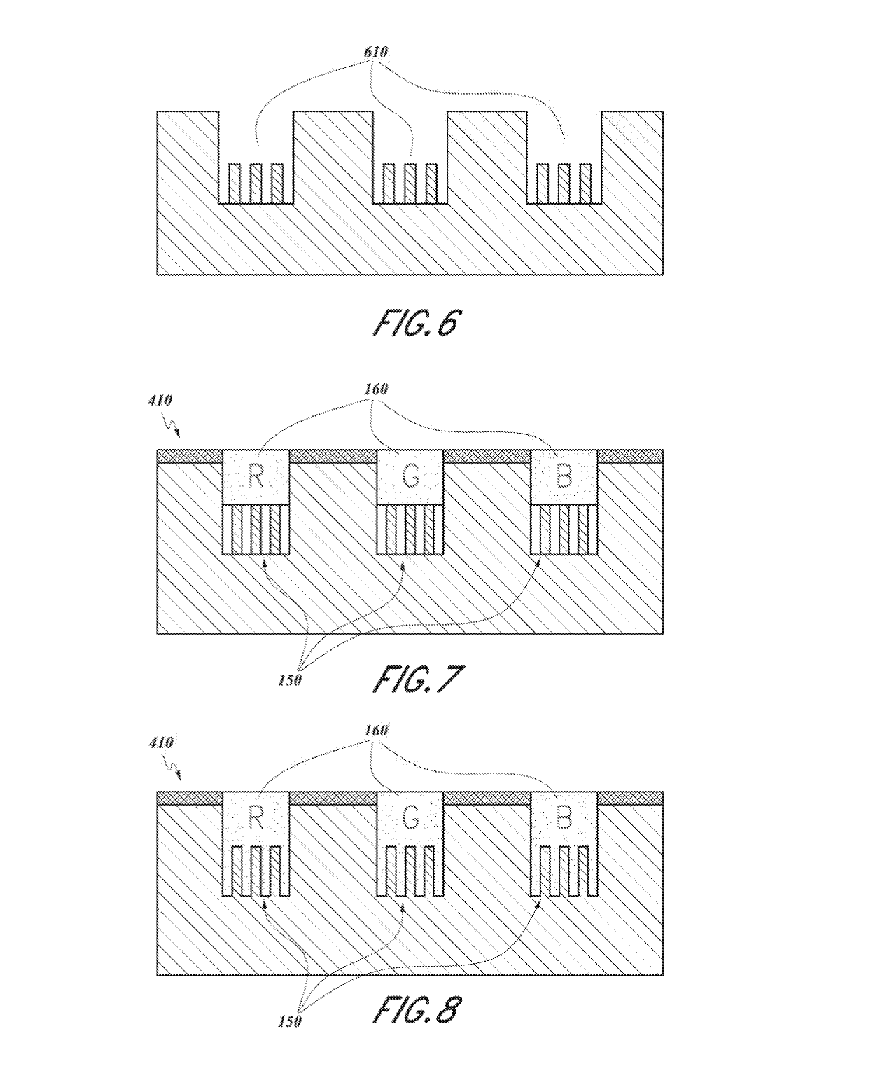

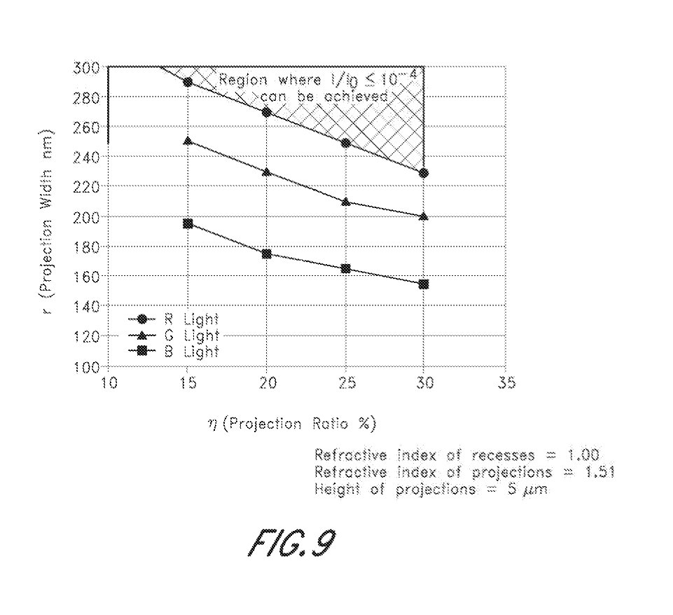

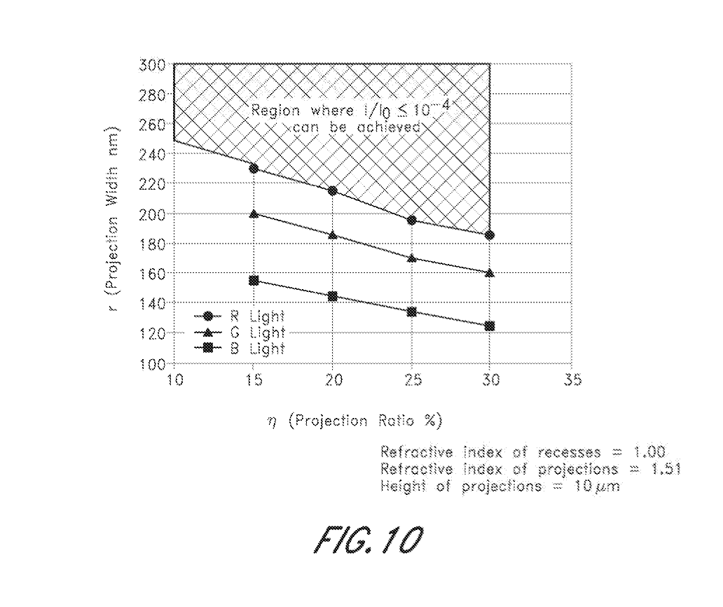

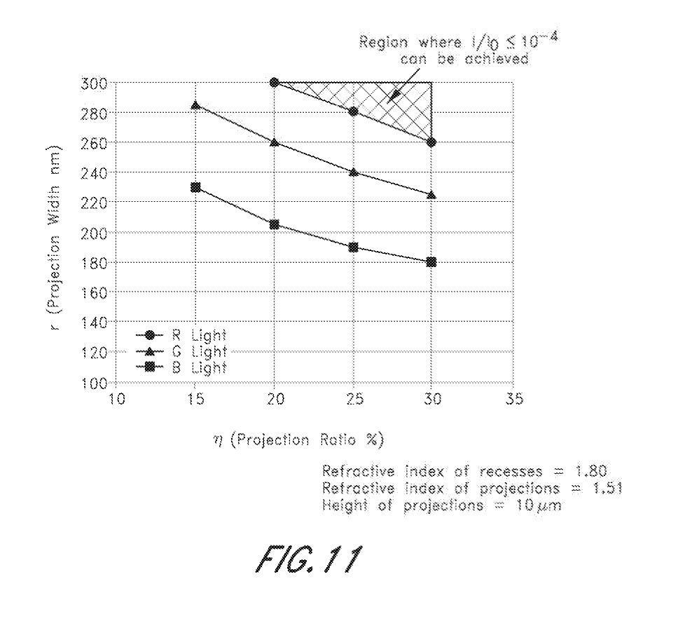

Referring to FIG. 6, there is illustrated another embodiment of a LCD glass substrate 170 with embedded polarizing regions 150. Referring to FIG. 6, the glass substrate 170 can include divots 610 for receiving color pixels 160. FIGS. 7-8 illustrate a LCD glass substrate 170 with color pixels 160 embedded within the divots 610 and on top of the polarizing regions 150. FIGS. 7-8 also illustrate a black matrix 410 formed on regions of the substrate free of the polarizing regions 150 and the color pixels 160. The black matrix 410 can define a plurality of openings between pairs of the polarizing regions 150. The recesses 320 can contain air, as illustrated in FIG. 7, or the recesses 320 can contain a color pixel 160, as illustrated in FIG. 8. As illustrated in FIGS. 7-8, the color pixels 160 can be formed inside the divots 610 and thus inside the glass substrate 170, thus reducing the thickness of a LCD device 100.

In some embodiments, the design of the dimensions of the projections 310 and recesses 320 of a polarizing region 150 can be guided by the color of the color pixel 160 disposed on top of that polarizing region 150. For example, the polarizing regions 150 with a red color pixel 162 disposed on top can have projections 310 with individual widths of about 180 nm to about 300 nm, such as, about 180 nm, about 200 nm, about 220 nm, about 240 nm, about 260 nm, about 280 nm, about 300 nm, or a width between any of these values. As another example, polarizing regions 110 with a green color pixel 164 can have projections 310 with individual widths of about 160 nm to about 280 nm, such as about 160 nm, about 180 nm, about 200 nm, about 220 nm, about 240 nm, about 260 nm, about 280 nm, or a width between any of these values. As another example, polarizing regions 110 with a blue color pixel 166 can have projections 310 with individual widths of about 120 nm to about 230 nm, such as about 120 nm, about 140 nm, about 160 nm, about 180 nm, about 200 nm, about 220 nm, about 230 nm, or a width between any of these values. In some embodiments, the projection 310 ratio is about 15% to about 30% as described above (for example, the projections 310 occupy a total width of about 15% to about 30% of the width of the nanostructure array). The projection ratio can be dependent on the color of the color pixel 160 disposed on top of the polarizing region 150, as will be explained in more detail below with respect to FIGS. 9-13. The individual height of the projections 310 is about 5 μm to about 20 μm relative to the recesses 320 according to some embodiments and as described above. In addition, the projections 310 and recesses 320 are at a constant pitch according to some embodiments and as described above.

In some embodiments, the refractive index of the projections 310, the refractive of the recesses 320, the height of the projections 310, the width of the projections 310, and projection 310 ratio, are designed so that the transmission coefficient is equal to or less than about 10⁻⁴ for light that is orthogonal to the projections 310 and recesses 320. Specifically, these parameters can be determined according to formulas (1), (2), and (3) shown below:

$$\begin{matrix}{C}_{sca} = \frac{8}{3} {( \frac{2 π {n}_{p} r}{λ} )}^{4} {( \frac{{m}^{2} - 1}{{m}^{2} + 2} )}^{2} π {r}^{2} & ( 1 ) \\ \begin{matrix}{α}_{sca} = n \times {C}_{sca} \\ = \frac{3 η}{4 π {r}^{3}} \times {C}_{sca}\end{matrix} & ( 2 ) \\ I = {I}_{0} \times {e}^{- {α}_{sca} L} \\ \frac{I}{{I}_{0}} = {e}^{- {α}_{sca} L} ≦ {10}^{- 1} & ( 3 )\end{matrix}$$

In formulas (1), (2), and (3), light scattered by a projection is regarded as light scattered by a particle having a diameter equal to the width of the projection 310. Thus, nₚ=the refractive index of a projection 310; r=the width of a projection 310; λ=the wavelength of light (for example, red, green, or blue light); m=nₚ/nₘ where nₘ is the index of refraction of a recess 320; η=the projection 310 ratio; C_{sca}=scattering cross-section; I=transmitted light intensity; I₀=incident light intensity; I/I₀=transmission coefficient; and L=height of a projection 310.

In some embodiments, projections 310 wider than 300 nm do not improve the transmission coefficient because at widths greater than 300 nm, light is diffracted but not scattered. Thus, in some embodiments, the maximum width of the projections 310 is 300 nm. In some embodiments, the maximum projection 310 ratio is 30% due to practical considerations during manufacturing.

Using formulas (1), (2), and (3), FIG. 9 plots a graph of η (the projection 310 ratio) vs. r (the width of the projections 310) when the refractive index of the recesses 320 is 1.00 (for example, the recesses 320 contain air), the refractive index of the projections 310 is 1.51 (for example, the refractive index of the glass substrate is 1.51), and the height of the projections 310 is 5 μm. FIG. 9 illustrates plots for light having a wavelength of 656 nm (red light), 589 nm (green light), and 486 nm (blue light). Referring to FIG. 9, the area above the plotted lines represents the values of η (the projection 310 ratio) and r (the width of the projections 310) for which a transmission coefficient of 10⁻⁴ or less can be achieved for each respective wavelength of light. For example, for red light, a transmission coefficient of 10⁻⁴ or less can be achieved with a projection 310 ratio of 15% and a projection 310 width between 290 nm and 300 nm; a projection 310 ratio of 20% and a projection 310 width between 270 nm and 300 nm; a projection ratio of 25% and a projection 310 width between 250 nm and 300 nm; and a projection ratio of 30% and a projection 310 width between 230 nm and 300 nm. Similarly, for green light, a transmission coefficient of 10⁻⁴ or less can be achieved with a projection 310 ratio of 15% and a projection 310 width between 250 nm and 300 nm. Table 1 below summarizes the values plotted in FIG. 9.

TABLE 1

| Light Color | Projection Ratio | Projection Width (nm) |
|---|---|---|
| Red Light | 15% | 290-300 |
| | 20% | 270-300 |
| | 25% | 250-300 |
| | 30% | 230-300 |
| Green Light | 15% | 250-300 |
| | 20% | 230-300 |
| | 25% | 210-300 |
| | 30% | 200-300 |
| Blue Light | 15% | 195-300 |
| | 20% | 175-300 |
| | 25% | 165-300 |
| | 30% | 155-300 |

Refractive index of recesses = 1.00
Refractive index of projections = 1.51
Height of projections = 5 μm

Thus, in order to achieve a transmission coefficient of 10⁻⁴ or less when the refractive index of the recesses 320 is 1.00 (for example, when the recesses 320 contain air), when the refractive index of the projections 310 is 1.51 (for example, when the refractive index of the LCD glass substrate 170 is 1.51), and when the height of the projections is 5 μm, the projection 310 ratio and projection 310 width should be chosen according to the graph in FIG. 9 and Table 1 for each respective color of light. Accordingly, the parameters of each polarizing region 150 can be designed depending on the color of the color pixel 160 disposed on top of that polarizing region 150. For example, for a polarizing region 150 with a red color pixel 162 disposed on top of it, the nanostructures in that polarizing region 150 can have a projection ratio of 15% and individual projection widths between 290 nm and 300 nm, or a projection ratio and individual projection widths of the values illustrated in FIG. 9 and Table 1.

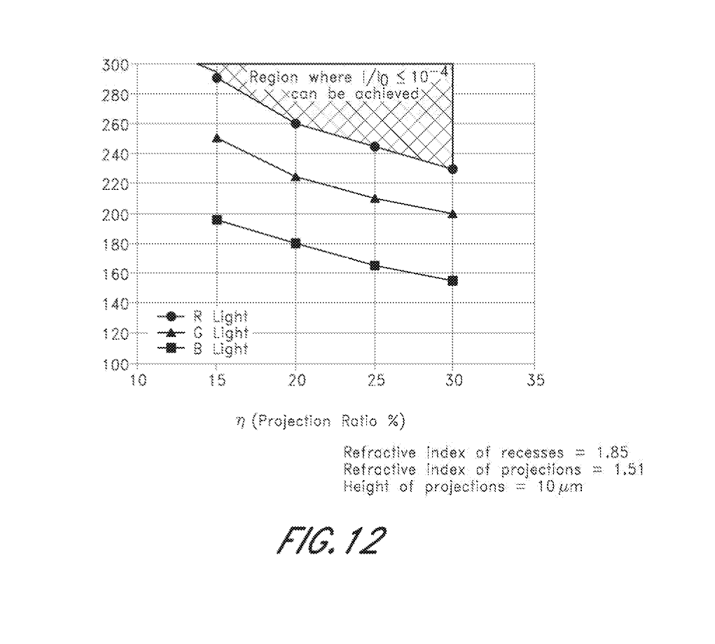

FIG. 10 illustrates a graph of η (the projection 310 ratio) vs. r (the width of the projections 310) with parameters that are the same as that of FIG. 9, except that the height of the projections 310 is 10 μm. Table 2 below summarizes the values plotted in FIG. 10. —

TABLE 2

| Light Color | Projection Ratio | Projection Width (nm) |
|---|---|---|
| Red Light | 15% | 230-300 |
| | 20% | 215-300 |
| | 25% | 195-300 |
| | 30% | 185-300 |
| Green Light | 15% | 200-300 |
| | 20% | 185-300 |
| | 25% | 170-300 |
| | 30% | 160-300 |
| Blue Light | 15% | 155-300 |
| | 20% | 145-300 |
| | 25% | 130-300 |
| | 30% | 125-300 |

Refractive index of recesses = 1.00
Refractive index of projections = 1.51
Height of projections = 10 μm

As illustrated in FIGS. 9-10 and Tables 1-2, increasing the height of the projections 310 allows a transmission coefficient of 10⁻⁴ or less to be achieved with a wider range of projection 310 widths. Thus, in some embodiments, it may be preferable to increase the height of the projections 310.

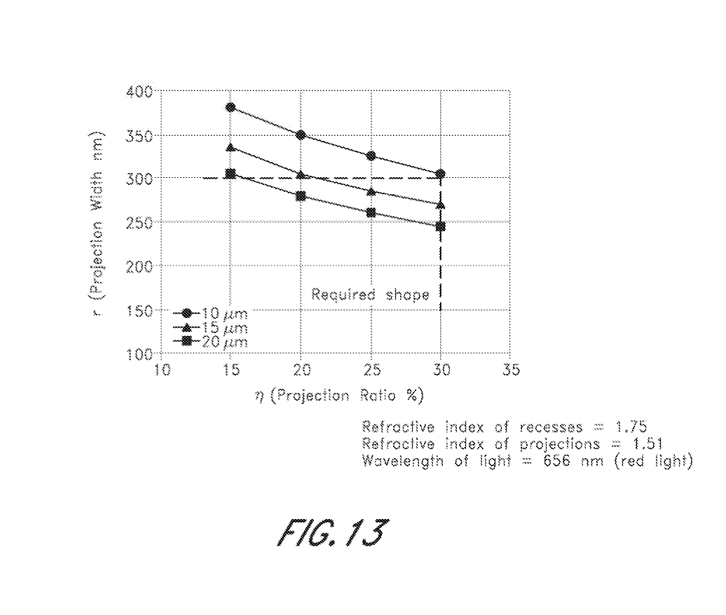

Using formulas (1), (2), and (3), FIGS. 11-13 illustrate graphs of η (the projection 310 ratio) and r (the width of the projections 310) when the recesses 320 contain a color pixel 160 with different indices of refraction. FIG. 11 illustrates a graph of η (the projection 310 ratio) vs. r (the width of the projections 310) when the refractive index of the recesses 320 is 1.80 (for example, the recesses contain a color pixel having a refractive index of 1.80), the refractive index of the projections 310 is 1.51 (for example, the glass substrate has a refractive index of 1.51), and the height of the projections is 10 μm. FIG. 11 illustrates plots for light having a wavelength of 656 nm (red light), 589 nm (green light), and 486 nm (blue light). Referring to FIG. 11, the area above the plotted lines represents the values of η (the projection 310 ratio) and r (the width of the projections 310) for which a transmission coefficient of 10⁻⁴ can be achieved for each respective wavelength of light. For example, for red light, a transmission coefficient of 10⁻⁴ or less can be achieved with a projection 310 ratio of 30% and a projection 310 width between 260 nm and 300 nm. Table 3 summarizes the values plotted in FIG. 11.

TABLE 3

| Light Color | Projection Ratio | Projection Width (nm) |
|---|---|---|
| Red Light | 20% | 300 |
| | 25% | 280-300 |
| | 30% | 260-300 |
| Green Light | 15% | 285-300 |
| | 20% | 260-300 |
| | 25% | 240-300 |
| | 30% | 225-300 |
| Blue Light | 15% | 230-300 |
| | 20% | 205-300 |
| | 25% | 190-300 |
| | 30% | 180-300 |

Refractive index of recesses = 1.80
Refractive index of projections = 1.51
Height of projections = 10 μm

Thus, in order to achieve a transmission coefficient of 10⁻⁴ when the refractive index of the recesses 320 is 1.80, when the refractive index of the projections 310 is 1.51, and when the height of the projections is 10 μm, the projection 310 ratio and projection 310 width should be chosen according to the graph in FIG. 11 and Table 3 for each respective color of light. Accordingly, the parameters of each polarizing region 150 can be designed depending on the color of the color pixel 160 disposed on top of the polarizing region 150. For example, for a polarizing region 150 with a red color pixel 162 disposed on top of it, the nanostructures in that polarizing region 150 can have a projection ratio of 30% and individual projection widths between 260 nm and 300 nm, or a projection ratio and individual projection widths of the values illustrated in FIG. 11 and Table 3.

FIG. 12 illustrates a graph of η (the projection 310 ratio) vs. r (the width of the projections 310) with parameters that are the same as that of FIG. 11, except that the refractive index of the recesses 320 is 1.85 (for example, the recesses contain a color pixel having a refractive index of 1.85). Table 4 summarizes the values plotted in FIG. 12.

TABLE 4

| Light Color | Projection Ratio | Projection Width (nm) |
|---|---|---|
| Red Light | 15% | 290-300 |
| | 20% | 270-300 |
| | 25% | 250-300 |
| | 30% | 230-300 |
| Green Light | 15% | 250-300 |
| | 20% | 225-300 |
| | 25% | 210-300 |
| | 30% | 200-300 |
| Blue Light | 15% | 195-300 |
| | 20% | 180-300 |
| | 25% | 165-300 |
| | 30% | 155-300 |

Refractive index of recesses = 1.85
Refractive index of projections = 1.51
Height of projections = 10 μm

As illustrated in FIGS. 11-12 and Tables 3-4, increasing the refractive index of the recesses 320 (for example, increasing the refractive index of the color pixels 160) allows a transmission coefficient of 10⁻⁴ or less to be achieved with a wider range of projection 310 widths. However, increasing the refractive index of the color pixels excessively results in considerable reflection loss at the interface between the glass substrate and the color pixels 160.

In addition, excessively decreasing the refractive index of the color pixels 160 requires projection 310 widths and projection 310 ratios that are not ideal to achieve a transmission coefficient of 10⁻⁴ or less. As explained above with respect to formulas (1), (2), and (3), in some embodiments, the maximum width of the projections 310 is 300 nm and the maximum projection 310 ratio is 30%. However, as illustrated in FIG. 13, when the refractive index of the recesses 320 is lower than 1.80, in particular 1.75, (for example, when the recesses 320 contain a color pixel 160 with a refractive index of 1.75), projection 310 widths greater than 300 nm may be required to achieve a transmission coefficient of 10⁻⁴ or less. FIG. 13 illustrates a plot of η (the projection 310 ratio) vs. r (the width of the projections 310) when the refractive index of the recesses 320 is 1.75, the refractive index of the projections 310 is 1.51, and the wavelength of light is 656 (red light). FIG. 13 illustrates plots for projections 310 having heights of 10 μm, 15 μm, and 20 μm. Referring to FIG. 13, in order to achieve a transmission coefficient of 10⁻⁴ or less with feasible projection 310 widths (e.g., projection widths equal to or less than 300 nm) when the refractive index of the recesses is 1.75, the projection 310 height should be increased considerably to 15 μm or 20 μm. In some embodiments, it may be difficult to form projections with line heights greater than 20 μm. Table 5 summarizes the values plotted in FIG. 13.

TABLE 5

| Projection Height | Projection Ratio | Projection Width (nm) |
|---|---|---|
| 10 μm | 15% | 380* |
| | 20% | 350* |
| | 25% | 330* |
| | 30% | 300 |
| 15 μm | 15% | 340* |
| | 20% | 300 |
| | 25% | 280-300 |
| | 30% | 270-300 |
| 20 μm | 15% | 300 |
| | 20% | 280-300 |
| | 25% | 260-300 |
| | 30% | 245-300 |

Refractive index of recesses = 1.75
Refractive index of projections = 1.51
Wavelength of light = 656 nm (red light)
*Because the projection width is greater than 300 nm, light may be diffracted but not scattered. Thus, the dimensions of the projection width and the corresponding projection ratios and projection heights may not achieve the desired transmission coefficient of 10⁻⁴ or less.

Accordingly, considering the effects of excessively decreasing or excessively increasing the refractive index of the recesses 320 (for example, the refractive index of the color pixel 160 contained in the recess 310), a preferred refractive index of the recesses 320 can range from 1.80 to 1.85 according to some embodiments.

In some embodiments, a method of making a LCD glass substrate 170 with embedded color filtering functionality is significantly simplified compared to conventional methods of making a color filter on a glass substrate. In addition, the LCD glass substrates made according to the methods described herein contain the advantage of having embedded polarizing functionality, thus removing the need for adding a separate polarizer to a LCD device.

Conventional methods of making a color filter require a multitude of steps, such as: applying a colored polyimide precursor to a glass substrate with a black matrix formed thereon, applying a photoresist, exposing the substrate, developing the substrate, removing the photoresist, and repeating the aforementioned steps for different colors (for example, red, green, and blue). In contrast, the methods of forming a color filter described herein are simplified compared to conventional methods.

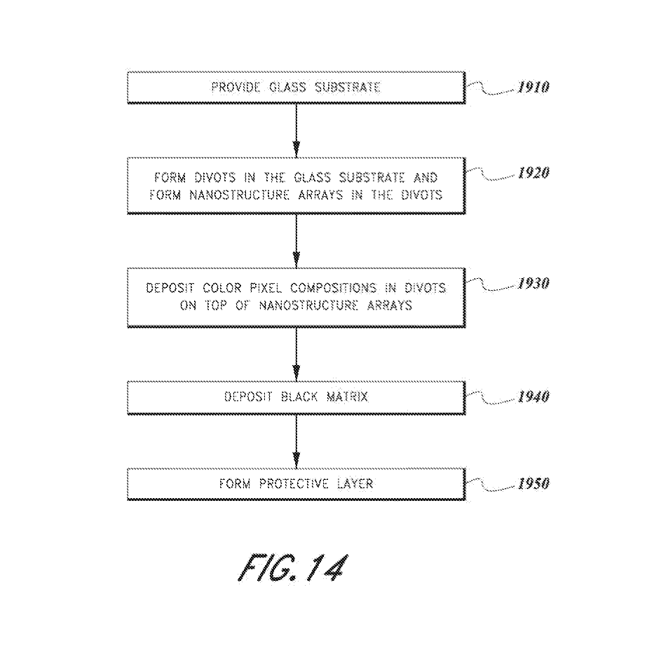

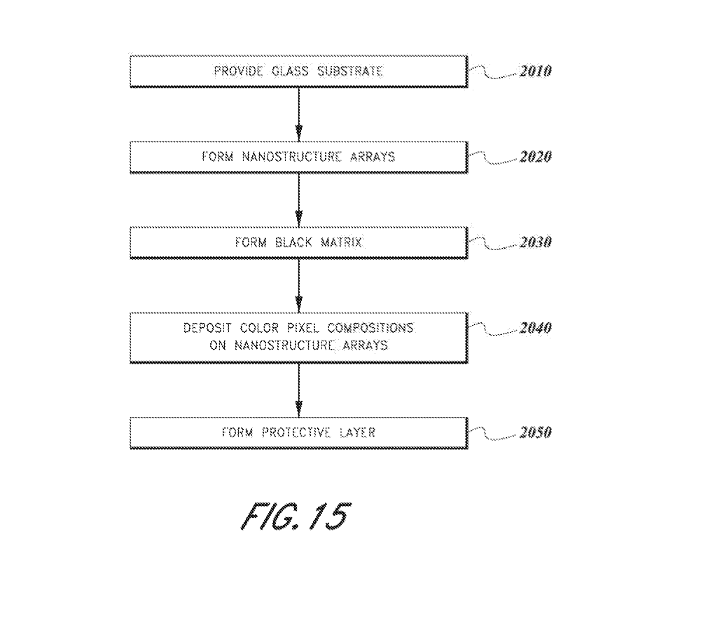

FIG. 14 illustrates one embodiment of a method of making a LCD glass substrate 170 with embedded polarizing functionality and embedded color filtering functionality. At step 1910, a glass substrate 170 is provided. In some embodiments, the refractive index of the LCD glass substrate 170 ranges from about 1.40 to about 1.64, such as, about 1.40, about 1.44, about 1.48, about 1.52, about 1.56, about 1.60, about 1.64, or a refractive index in between any of these values. For example, the refractive index of the glass substrate 170 can be about 1.51. At step 1920, divots 610 can be formed in the glass substrate 170 for receiving a color pixel 160. The divots 610 may be formed by glass imprinting, overflow methods, download methods, or any other suitable method. Also at step 1920, an array of nanostructures, such as a plurality of parallel projections 310 and recesses 320, can be formed in each divot 610 by imprinting, for example, glass imprinting. In some embodiments, the divots 610 and the nanostructures may be formed at the same time. The nanostructure arrays in the divots 610 can be formed according to any suitable method known in the art. For example, according to one method of imprinting, a pattern of projections and recesses are formed on a roller. Next, the projections and recesses are transferred from the roller to a thin glass plate at a temperature which is greater than or equal to the glass transition temperature. The projections and recesses can be imprinted onto the glass substrate 170 according to an overflow method. In other embodiments, the projections and recesses can be imprinted onto the glass substrate according to a download method.

Still referring to FIG. 14, each array of nanostructures in the divots 610 can form a polarizing region 150 configured to polarize light. In some embodiments, the dimensions of the nanostructures in one array can be different from the dimensions of the nanostructures in another array. Specifically, some embodiments have multiple subsets, for example three subsets, of nanostructure arrays, each subset with dimensions that are different from those of another subset. Each subset of nanostructure arrays can be configured to polarize different colored lights, such as red, green, and blue light. Thus, at step 1920, three subsets of nanostructure arrays can be formed, each subset with different nanostructure dimensions, and each subset configured to polarize a different color of light. In addition, the subsets of nanostructure arrays can be arranged in a RGB three color pattern.

The dimensions of the nanostructures in each array can be guided by the discussion above with respect to FIGS. 9-13 and Tables 1-5. Specifically, the dimensions can be designed so that the polarizing regions 150 have a transmission coefficient of about 10⁻⁴ or less. For example, one subset of nanostructure arrays can have parallel projections 310 and recesses 320 with dimensions configured to polarize red light. For example, as discussed above with respect to FIG. 11 and Table 1, those projections 310 can have a projection ratio of 15%, individual widths of 230 nm to 300 nm, and individual heights of 10 μm. As another the example, another subset of nanostructure arrays can have parallel projections 310 and recesses 320 with different dimensions configured to polarize green light. Those projections 310 can have a proportion ratio of 15%, individual widths of 200 nm to 300 nm, and individual heights of 10 μm, as discussed above with respect to FIG. 11 and Table 1. As another example, another subset of nanostructure arrays can have parallel projections 310 and recesses 320 with different dimensions configured to polarize blue light. Those projections can have a projection ratio of 15%, individual widths of 155 nm to 300 nm, and individual heights of 10 μm, as discussed above with respect to FIG. 11 and Table 1.

Referring to FIG. 14, after forming the plurality of nanostructure arrays in the divots 610, color pixel compositions 160 can be deposited in the divots 610 and on top of the nanostructure arrays at step 1930. Specifically, a red color pixel composition 162 can be deposited on top of the subset of nanostructure arrays configured to polarize red light, a green color pixel composition 164 can be deposited on top of the subset of nanostructure arrays configured to polarize green light, and a blue color pixel composition 166 can be deposited on top of the subset of nanostructure arrays configured to polarize blue light. In some embodiments, the color pixel compositions 160 are deposited on top of the nanostructure arrays without filling the recesses 320. Thus, in those embodiments, the recesses 320 include air. In other embodiments, the color pixel compositions 160 fill the recesses when the color pixel compositions 160 are deposited onto the nanostructure arrays. Thus, in those embodiments, the recesses 320 include a color pixel composition 160. Regardless of whether the recesses 320 contain air or a color pixel composition 160, the refractive index of the recesses 320 is different from the refractive index of the projections 310 according to some embodiments.

In some embodiments, a method of making a LCD glass substrate 170 includes the step of preparing the color pixel compositions 160. In some embodiments, the color pixel compositions 160 can be nanoparticle-based instead of pigment based. A method of preparing the color pixel composition 160 can include dispersing inorganic nanoparticles in a chemically stable matrix having high heat resistance. Examples of such matrices include polysilsesquioxane, polycarbosilane, polyborosilazane, polycarbosilazane, polyborosiloxane, or a combination thereof. In some embodiments, the concentration of nanoparticles dispersed in the matrix may be about 10%, 15%, 20%, 25%, 30%, 35%, 40%, or a concentration in between any of these values.

The material of the inorganic nanoparticles used in the color pixel composition 160 can be gold (Au), silver (Ag), copper (Cu), or any combination thereof. In addition, the inorganic nanoparticles can have an average diameter of about 2 nm to about 20 nm, such as, about 2 nm, about 4 nm, about 6 nm, about 8 nm, about 10 nm, about 12 nm, about 14 nm, about 16 nm, about 18 nm, about 20 nm, or a diameter in between any of these values; in some embodiments, the average diameter is 10 nm. The inorganic nanoparticles can be used to control the color of the color pixel compositions 160 as well as the refractive index of the color pixel compositions 160. For example, dispersing different amounts gold (Au), silver (Ag), and/or copper (Cu) can affect the color of the composition. For example, in some embodiments, the nanoparticles can include a shell and a core. Nanoparticles with a gold core and a silver shell can exhibit colors ranging from red to orange to yellow. Nanoparticles with a copper shell can exhibit colors ranging from red to violet to blue to bluish green. The refractive index of the color pixel composition 160 can be controlled by selecting nanoparticles with the proper refractive index.

Still referring to FIG. 14, after color pixel compositions 160 are deposited in the divots 610 and on top of the polarizing regions 150, at step 1940 a black matrix 410 can be deposited on regions of the substrate 170 free of the polarizing regions 150 and free of the color pixel compositions. The black matrix 410 can define a plurality of openings between pairs of the polarizing regions 150. In some embodiments, a method of making a LCD glass substrate 170 includes the step of preparing the black matrix composition 410 by dispersing chromium metal, carbon, titanium, or nickel, in a heat-resistant matrix such as polysilsesquioxane, polycarbosilane, polyborosilazane, polycarbosilazane, polyborosiloxane, or a combination thereof. In some embodiments, the black matrix 410 and color pixels 160 are deposited onto the glass substrate 170 by offset printing. In other embodiments, the black matrix 410 and color pixels 160 are deposited onto the glass substrate 170 by ink-jet printing. In some embodiments, the black matrix 410 and the color pixel compositions 160 are cured after they are deposited onto the glass substrate 170. Referring to FIG. 14, at step 1950 a protective layer, such as a film of polyimide or a film of epoxy, can be formed on top of the color pixels 160 and the black matrix 410. In some embodiments, the step of forming a protective layer can be omitted.

FIG. 15 illustrates another method of making a LCD glass substrate 170 with embedded polarizing functionality and embedded color-filtering functionality. In this embodiment, divots 610 are not formed in the glass substrate 170. Referring to FIG. 15, at step 2010 a glass substrate 170 is provided. At step 2020, an array of nanostructures, specifically a plurality of parallel projections 310 and recesses 320, can be formed by glass imprinting. In some embodiments, three subsets of nanostructure arrays are formed, each for polarizing a different colored light (for example, red, green, and blue). The subsets can be arranged in a RGB three color pattern. At step 2030, a black matrix 410 can be formed on regions of the substrate 170 outside of the polarizing regions 150. The black matrix 410 can define a plurality of openings between pairs of the polarizing regions 150. At step 2040, a red 162, green 164, and blue 166 color pixel composition can be deposited on a respective nanostructure array. In some embodiments, the black matrix 410 and the color pixel compositions 160 are cured after they are deposited onto the glass substrate 170. At step 2050 a protective layer, such as a film of polyimide or a film of epoxy, can be formed on top of the color pixels 160 and the black matrix 410. In some embodiments, the step of forming a protective layer may be omitted.

### Example 1

### Preparing a Red Color Pixel Composition

Gold inorganic nanoparticles with a diameter of 10 nm are provided. The inorganic particles are dispersed in polysilsesquioxane. Thus, a red color pixel composition is prepared.

### Example 2

### Preparing a Green Color Pixel Composition

Gold nanoparticles with a diameter of 10 nm are provided. Copper nanoparticles with a diameter of 10 nm are provided. The inorganic particles are dispersed in polysilsesquioxane. The weight ratio of gold nanoparticles to copper nanoparticles is 1:2. Thus, a green color pixel composition is prepared.

### Example 3

### Preparing a Blue Color Pixel Composition

Gold nanoparticles with a diameter of 10 nm are provided. Copper nanoparticles with a diameter of 10 nm are provided. The inorganic particles are dispersed in polysilsesquioxane. The weight ratio of gold nanoparticles to copper nanoparticles is 1:1. Thus, a blue color pixel composition is prepared.

### Example 4

### Making a Substrate Having Polarizer and Color Filter Functions

A red color pixel composition is prepared in the same manner as in Example 1. A green color pixel composition is prepared in the same manner as in Example 2. A blue color pixel composition is prepared in the same manner as in Example 3.

A glass substrate with a refractive index of 1.51 is provided. A plurality of divots is formed in the glass substrate by glass imprinting. Using glass imprinting, a plurality of nanostructure arrays is embedded in the divots. Each of the nanostructure arrays forms a polarizing region. Three subsets of polarizing regions are formed; one subset to polarize red light, another subset to polarize green light, and another subset to polarize blue light. Each of the polarizing regions has parallel projections and recesses. The refractive index of the projections is the same as that of the glass substrate. The height of the projections is 10 μm. The subset configured to polarize red light has individual projection widths of 220 nm and a projection ratio of 20%. The subset configured to polarize green light has individual projection widths of 220 nm and a projection ratio of 20%. The subset configured to polarize blue light has individual projection widths of 220 nm and a projection ratio of 20%.

Using ink-jet printing, red color pixel compositions are deposited in the divots and on top of the subset configured to polarize red light. The red color pixel compositions are deposited such that the recesses in the nanostructure arrays do not include the color pixel and instead contain air. Thus, the refractive index of the recesses in the subset configured to polarize red light is 1.00.

Using ink-jet printing, green color pixel compositions are deposited in the divots and on top of the subset configured to polarize green light. The green color pixel compositions are deposited such that the recesses in the nanostructure arrays do not include the color pixel and instead contain air. Thus, the refractive index of the recesses in the subset configured to polarize green light is 1.00.

Using ink-jet printing, blue color pixel compositions are deposited in the divots and on top of the subset of nanostructure arrays configured to polarize blue light. The blue color pixel compositions are deposited such that the recesses in the nanostructure arrays do not include the color pixel and instead contain air. Thus, the refractive index of the recesses in the subset configured to polarize blue light is 1.00,

A black matrix is deposited on the substrate on regions free of the nanostructure arrays using ink-jet printing. The black matrix is cured. The color pixel compositions are cured. A protective layer is formed. Thus, a substrate having polarizer and color filter functions is made. For example, light incident on the color pixel composition generates surface plasmon resonance.

### Example 5

### Making and Using a Liquid Crystal Display

A substrate is made in the same manner as in Example 4. This substrate is used as the top substrate for a LCD. An ITO (indium tin oxide) layer is formed on the top substrate. A bottom substrate is provided. An ITO layer is formed on the bottom substrate. A polarizer is disposed beneath the bottom substrate. With reference to FIG. 1, the top substrate 170 is oriented so that the polarizing regions 150 and color filters 160 are on the top surface of the top substrate 170. Still referring to FIG. 1, the bottom substrate 130 is oriented so that the polarizer 120 is on the bottom surface of the bottom substrate 130. A spacer is placed between the top substrate's 170 bottom surface and the bottom substrate's 130 top surface. A liquid crystal layer 140 is inserted in the space created by the spacer using vacuum technology. Thus, referring to FIG. 1, the polarizing regions 150 and the color filters 160 face away from the liquid crystal layer 140. In addition, the polarizer 120 on the bottom substrate 130 faces away from the liquid crystal layer. A backlight unit 110 is disposed beneath the bottom substrate 130. Additional supporting components are built into the device according to methods known in the art to make a liquid crystal display. The liquid crystal display is then used in normal operation while exhibiting color-filtering and polarizing functionality. The Examples disclosed herein demonstrate that it is possible to omit conventional polarizers and color filters by embedding polarizing functionality and color-filtering functionality into the glass substrate.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A substrate comprising:
a plurality of polarizing regions configured to polarize light, each polarizing region comprising at least one array of nanostructures embedded in the substrate,
wherein the at least one array of nanostructures comprises parallel projections and recesses,
wherein a refractive index of the projections is different from a refractive index of the recesses,
wherein each polarizing region has a transmission coefficient equal to or less than about 10⁻⁴ for light orthogonal to the parallel projections and recesses, and
wherein the plurality of polarizing regions comprise:
a red polarizing region configured to polarize light having a wavelength of about 620 nm to about 750 nm,
a green polarizing region configured to polarize light having a wavelength of about 495 nm to about 570 nm, and
a blue polarizing region configured to polarize light having a wavelength of about 450 nm to about 495 nm.

2. The substrate of claim 1, wherein the parallel projections and recesses have a constant pitch.

3. The substrate of claim 0, wherein the refractive index of the projections is about 1.40 to about 1.64.

4. The substrate of claim 1, wherein the refractive index of the projections is about 1.51.

5. The substrate of claim 0, wherein the recesses comprise air with a refractive index of about 1.

6. The substrate of claim 0, wherein each of the recesses comprise a color pixel with a refractive index of about 1.80 to about 1.85.

7. The substrate of claim 0, further comprising at least one divot, each divot configured to receive a color pixel and the at least one array of nanostructures.

8. The substrate of claim 0, further comprising:
a black matrix formed on regions of the substrate outside of the polarizing regions, wherein the black matrix defines a plurality of openings between pairs of the polarizing regions; and
a plurality of color pixels disposed on the plurality of polarizing regions, wherein each of the color pixels is disposed on a respective polarizing region associated with a color of the color pixel.

9. The substrate of claim 1, wherein the color pixels are disposed on the polarizing regions such that the color pixels fill the recesses.

10. (canceled)

11. The substrate of claim 1, wherein the plurality of color pixels comprise:
at least one red color pixel disposed on the red polarizing region;
at least one green color pixel disposed on the green polarizing region; and
at least one blue color pixel disposed on the blue polarizing region.

12. The substrate of claim 1, wherein the color pixels are compositions comprising inorganic nanoparticles dispersed in polysilsesquioxane, polylsiloxane, polycarbosilane, polyborosilazane, polycarbosilazane, polyborosiloxane, or a combination thereof.

13. (canceled)

14. The substrate of claim 0, wherein the inorganic nanoparticles comprise gold (Au), silver (Ag), copper (Cu), or a combination thereof.

15. (canceled)

16. The substrate of claim 0, wherein the inorganic nanoparticles have an average diameter of about 2 nm to about 20 nm.

17. (canceled)

18. A liquid crystal display comprising:
a first substrate comprising:
a plurality of polarizing regions configured to polarize light, each polarizing region comprising an array of nanostructures embedded in the first substrate,
wherein the array of nanostructures comprises parallel projections and recesses,
wherein a refractive index of the projections is different from a refractive index of the recesses,
wherein each polarizing region has a transmission coefficient equal to or less than about 10⁻⁴ for light orthogonal to the parallel projections and recesses, and
wherein the plurality of polarizing regions comprise:
a red polarizing region configured to polarize light having a wavelength of about 620 nm to about 750 nm,
a green polarizing region configured to polarize light having a wavelength of about 495 nm to about 570 nm, and
a blue polarizing region configured to polarize light having a wavelength of about 450 nm to about 495 nm;
a black matrix formed on regions of the substrate outside of the polarizing regions, wherein the black matrix defines a plurality of openings between pairs of the polarizing regions; and
a plurality of color pixels disposed on the plurality of polarizing regions, wherein each of the color pixels is disposed on a respective polarizing region associated with a color of the color pixel;
a second substrate; and
a liquid crystal layer disposed between the first and second substrates.

19. The liquid crystal display of claim 0, wherein one or both of the first substrate and the second substrate are glass substrates.

20. A method of making a substrate, the method comprising:
forming a plurality of arrays of nanostructures embedded in the substrate, wherein each array of nanostructures comprises:
parallel projections and recesses,
wherein a refractive index of the projections is different from a refractive index of the recesses, and
wherein each array is configured to polarize light and has a transmission coefficient equal to or less than about 10⁻⁴ for light orthogonal to the parallel projections and recesses;
depositing a black matrix on regions of the substrate outside of the arrays of nanostructures, such that the black matrix defines a plurality of openings between pairs of the arrays of nanostructures; and
depositing a color pixel composition onto one or more of the plurality of arrays of nanostructures.

21. The method of claim 0, wherein forming the plurality of arrays of nanostructures comprises imprinting.

22. The method of claim 0,
wherein depositing the black matrix comprises ink-jet printing or offset printing; and
wherein depositing the color filter composition comprises ink-jet printing or offset printing.

23. The method of claim 0, further comprising:
forming a plurality of divots in the substrate, wherein each of the divots is configured to receive the color pixel composition and at least one of the plurality of arrays of nanostructures.

24. The method of claim 0, further comprising:
curing the black matrix;
curing the color pixel composition to form a color filter; and
forming a protective layer on the black matrix and the color filter.

25. (canceled)

26. The method of claim 0, further comprising:
preparing the color pixel composition by dispersing inorganic nanoparticles in polysilsesquioxane, polycarbosilane, polyborosilazane, polycarbosilazane, polyborosiloxane, or a combination thereof.

27. (canceled)

28. (canceled)

29. The method of claim 0, wherein the inorganic nanoparticles have an average diameter of about 10 nm.

30. The method of claim 0, further comprising:
controlling a refractive index of the color pixel composition by dispersing nanoparticles having a predetermined refractive index.

31. The method of claim 0, wherein the plurality of arrays of nanostructures form a plurality of polarizing regions.

32. The method of claim 0, wherein depositing the color pixel composition comprises:
depositing a red color pixel composition on an array of nanostructures that forms a red polarizing region;
depositing a green color pixel composition on an array of nanostructures that forms a green polarizing region; and
depositing a blue color pixel composition on an array of nanostructures that forms a blue polarizing region.

33. (canceled)
